(19) United States
(12) Patent Application Publication
(10) Pub. No.: US 2012/0185276 A1
(43) Pub. Date: Jul. 19, 2012

(54) System for Medication Information and Storage

(76) Inventor: Reshma Shah, Shaker Heights, OH (US)

(21) Appl. No.: 13/352,560

(22) Filed: Jan. 18, 2012

Related U.S. Application Data
(60) Provisional application No. 61/433,604, filed on Jan. 18, 2011.

(51) Int. Cl. A61J 1/00; G06Q 50/24; B65D 25/54

(52) U.S. Cl. 705/3; 206/570

(57) ABSTRACT

A system and method for storing medical information and medications for use in an emergency. The system includes a rigid storage container with personalized individual patient medical information on an external surface of the storage container, including a photograph of the individual patient, information regarding the contents of the storage container and emergency contact information. The method uses an internet-based computer system to generate a summary of patient medical information which is mounted for viewing on an external surface of the storage container. The summary is supplied and mounted for viewing from an external surface of the storage container. Once the medications are included within the storage container, a care giver is provided with the storage container for safe keeping in the event of a health emergency.

### CROSS-REFERENCE TO RELATED APPLICATIONS

The present application claims priority from, and incorporates herein by reference, the subject matter of U.S. application Ser. No. 61/433,604 filed Jan. 18, 2011.

### FIELD OF INVENTION

The present invention relates to a system for storing medication and information, and an internet or web based system for creating storage systems for containing medication and related medical information.

### BACKGROUND OF THE INVENTION

As the severity and prevalence of allergies, asthma and diabetes continue to increase, there is also an increasing need for the prompt availability of individualized treatment information and prescription antidotes. In the case of children, where food allergies affect up to 6% of all young children and asthma is the most common chronic medical condition of childhood, the need for emergency information may arise at a variety of inconvenient times, for example, at school or camp, such as during recess or field trips, when students are away from their class room or from the school or camp. In the case of adult employees, emergency information may be necessary when an individual is working on an assembly line, or away from available health information. Since information regarding student health issues, such as food allergies or asthmatic responses, and the associated emergency medications are normally kept in the classroom for application by a teacher, or with a school nurse or camp health care provider, the absence of vital information at the scene of an emergency can become critically important. As a result of the need for such information on an urgent basis, a need has arisen to provide better information which can be more promptly and accurately accessed, as well as readily transported.

### SUMMARY OF THE INVENTION

The present application provides a system for easily accessing medical information and medications for use by educators or other individuals assisting a child in a health emergency. The present application provides for an individualized storage container sufficient for storing emergency medications, such as Epipen® hypodermic injectors or epinephrine auto-inject syringes, insulin medications, blood testing or treatment materials and equipment, inhalers, or other oral medications, which have been prescribed for an individual patient. Additionally, the storage container is provided with information specific to the individual to enable ready identification, such as a photograph, name, age, weight, and the illness which may most commonly arise with respect to that individual. Specific information regarding the contents of the storage container may also be shown, so that easy identification of whether the desired antidote may be found within the storage container is possible. Lacking such information regarding the contents, a care giver may waste valuable time searching for an antidote, only to discover none is to be found. Where information regarding the contents of the storage container, or lack of contents, is provided externally of the storage container, it may enable a health care provider to more quickly make a 911 call for emergency assistance, instead of searching through the storage container in vain.

To ensure that the desired information is provided externally of the storage container, a website is provided to enable a patient or a parent of a child patient, to provide the desired information, and either immediately print the information for application to the storage container, or to have the information printed and shipped.

Once the storage container is provided with the necessary information externally of the container, and the medications or other antidotes are stored within the container, the container may be provided to the school or camp, or taken to a place of employment. At the location where the storage container is to be kept for emergency use, a further cabinet or other container may be provided. Such a storage cabinet, for example, located in the camp infirmary or the school nurse's office, is positioned to enable ready and easy identification of the patient to whom the individual containers belong. For example, the storage containers may be stored in such a way that a small end of each storage container is visible when multiple storage containers are stacked within the cabinet.

The present application thus provides a system for medication information and medication storage for prompt accurate access to necessary emergency health information. The present system may make use of an internet based system to provide a storage container with the necessary individualized patient information on the external surface of the storage container, as well as additional health information and medications within the storage container, such as necessary emergency medications or antidotes for an individual patient. Still further, the system may include a storage container for storing multiple individual storage containers for easy identification of an individual container for a specific patient in an emergency health situation.

### BRIEF DESCRIPTION OF THE DRAWINGS

FIG. 1 illustrates a perspective view of a closed container of the present application showing desired emergency medical information regarding an individual depicted on the container, the medical condition of the individual depicted, the medications contained within the container and additional emergency treatment and contact information.

FIG. 2 illustrates a top view of the container of FIG. 1, showing the medical condition of an individual who is also depicted, named and described on the container (date of birth and specific nut allergy, for example), desired emergency medical information regarding the individual depicted on the container (Severe Symptoms and Treatment for severe symptoms and Mild Symptoms and Treatment for mild symptoms, for example), and additional emergency contact information.

FIG. 3 illustrates an end view of the container of FIG. 1, showing the medical condition of an individual who is also named and described on the end panel of the container (date of birth and specific nut allergy, for example), and additional emergency contact information.

FIG. 4 illustrates an open container of the present application showing the medicines for the individual depicted on the container, and identified by printed name on the sides of the container, and the Treatment Action Plan or medical treatment instructions or information provided within the container.

FIG. 5 illustrates the open container of FIG. 1, with the medicine contents and emergency information removed for inspection.

FIG. 6 schematically illustrates the system components for implementing the system and method disclosed in the present application.

### DETAILED DESCRIPTION OF THE INVENTION

The present disclosure for a mediation, information and storage container 10, and a system and method for its creation, is designed to securely store the desired individual patient's emergency medications while clearly identifying the individual, their medical condition and information, and a treatment plan from an external surface of the container.

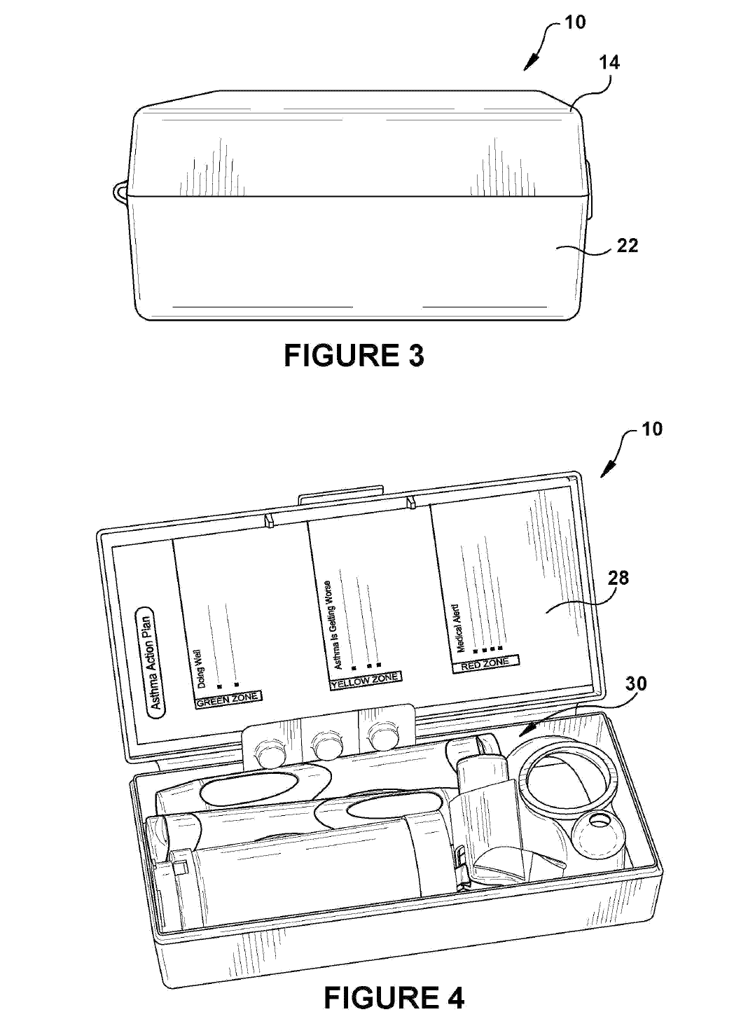

By placing the individual patient photo 12 for viewing from an external surface 14 of the storage container, nurses, teachers, and other care givers can easily recognize and access the medical information and medication during an emergency health care situation. Customizing the information for viewing from the outside of the container 10 emphasizes the specific details of the individual patient's specific condition 16, recommended treatment 18 and highlights emergency contact information 20. The convenient side label 22, shown in FIG. 3, also offers quick access information and more storage options for the storage container. Providing the information for viewing from an external surface 14 of the container 10 can be extremely helpful and provide critical time saving in certain settings, such as school or camp, where multiple individual patients may have medications being stored.

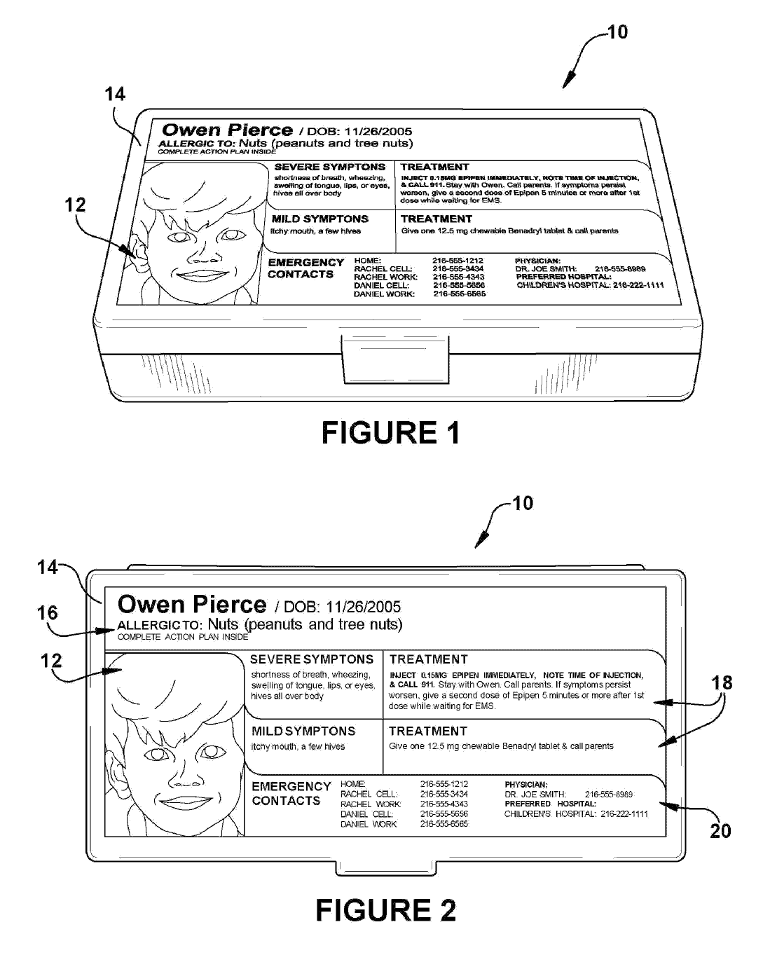

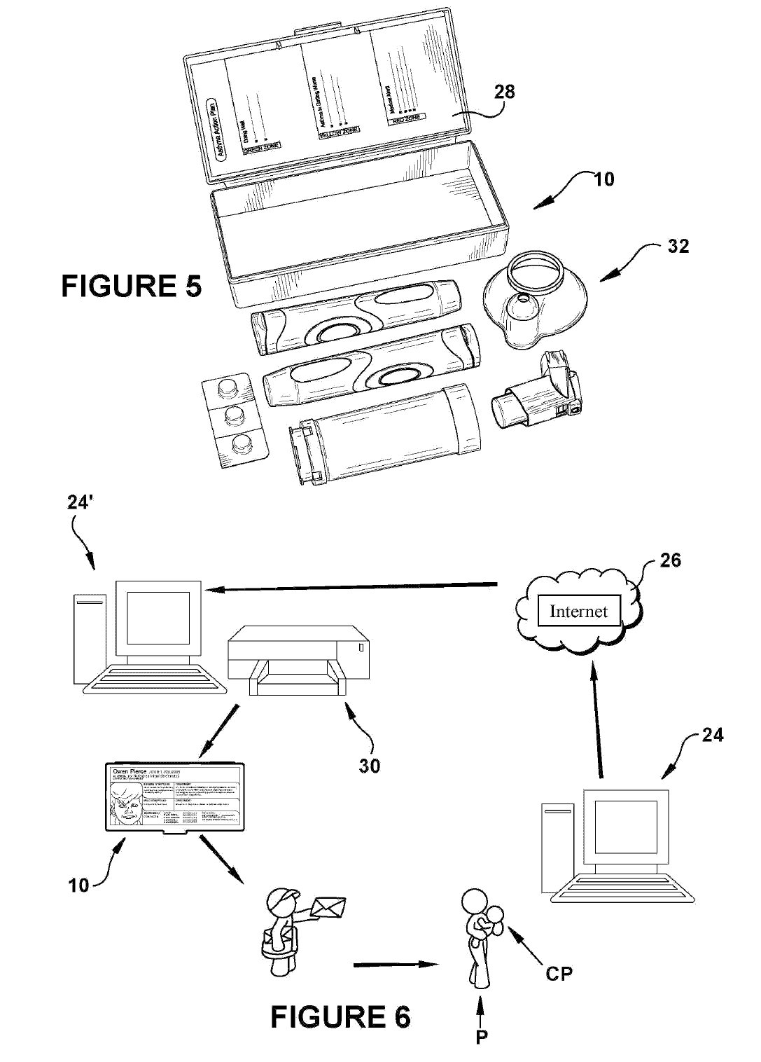

In FIGS. 1, 2 and 3 illustrate the semi-transparent, rigid, closed storage container 10 of the present application showing the desired emergency medical information regarding an individual depicted from an external surface of the container 14 , the medical condition 16 of the individual is depicted, and a list of the medications stored within the container, as well as additional emergency treatment 18 and contact information 20. In FIGS. 4 and 5, the open container shows the Treatment Action Plan or other medical treatment instructions 28 or information and the listed medications provided within the container.

With respect to information regarding the method and operating environment for supplying the storage container, there are numerous environments in which on-line ordering websites may operate. The present system and method is provided to be any suitable system for inputting private medical or confidential information by a parent of a child patient CP or an adult patient P, and for printing or manufacturing the information and providing it into or onto a container, and shipping the completed container 10 to the requesting parent or adult, where it may be provided with the necessary medicines or treatment equipment, in preparation for use in an emergency situation. It should be understood that the confidential health information provided by the parent or adult is not transferred to any third parties, but is merely formatted and printed for use in connection with the container system 10, as authorized by the ordering patient or adult P, in the case of a child patient CP. An exemplary environment includes one or more conventional computer devices in communication via a communication network, such as the Internet.

As schematically shown in FIG. 6, devices used to implement the purchase, manufacture and shipment of the present container 10 are typically computing devices including a variety of configurations or forms such as, but not limited to, laptop or tablet computers, personal computers, smart phones, work stations, and the like. Conventional computer components may be used for conducting the purchase and input of information for the container system, and for shipment of the present system according to the method. Of course, those skilled in the art of computers will recognize a wide selection of commercially available components that can be used to construct systems suitable for performing the components of the present system and method.

The computer system includes a buyers system, generally referenced at 24 and a sellers system generally referenced at 24′, which include a processor in communication with a variety of other components over a system bus. The other components include, by way of example, a network interface, an input device, interface, a display interface, a computer-readable medium drive, and a memory. As appreciated by those skilled in the art, the network interface enables the systems to communicate data, control signals, data requests, and other information with a computer network, such as the Internet 26. The network interface may be configured to communicate with the Internet 26 over a wired or wireless connection.

The input device interface sometimes also embodied as an input/output interface, enables the systems to be accessed for purchase 24 and shipment 24′ of a container system 10, and to obtain the data input for manufacturing the container. Input devices in communication with the input device interface may include, but are not limited to, a digital pen, a touch screen, a keyboard, a mouse, and the like. In addition, a display interface is typically connected to a display device (e.g., a CRT monitor, an LCD screen, a TV, etc.) for visually displaying information regarding the container system. Those skilled in the art may discern that the display device may be incorporated with a computer device as an integral element or, alternatively, may be an external component that is attached to the computer device.

A processor in the systems 24, 24′ is configured to operate in accordance with programming instructions stored in memory. The memory generally comprises RAM, ROM, and/or a permanent memory. Thus, in addition to storage in read/write memory (RAM), programming instructions may also be embodied in read-only format, such as those found in ROM or other permanent memory.

The memory also typically stores an operating system, for controlling the general operation of the computer device. The operating system may be a general purpose operating system such as Microsoft® operating system, for example. The memory may further store user executable applications or programs for conducting various functions on the computing device. For example, the memory includes a browser application that may be used by the Customer to navigate on the Internet and through which the Customer may communicate via the Internet to purchase and input data regarding the container system. Examples of such browser applications include Microsoft's Internet Explorer® or Mozilla's Firefox, and the like.

A computer readable medium drive provides an optional and alternative means by which a purchaser may store information externally and/or retrieve external information. Examples of computer readable medium drives include, but are not limited to CD ROM drives, DVD ROM drives, floppy disk drives, flash member readers, and the like.

Once the adult patient P has provided the necessary data or information is to the memory of the computer system 24′, the manufacture of the container using the system and method may be commenced, and the purchaser may be requested to perform a review operation within the system to confirm that the desired information has been input. The buyer's computer system is connected to the seller's system via a communication network, such as the Internet 26, using a confidential connection, perhaps a user name and password which is unique and provided on a confidential basis to each purchaser. Once the desired review of the information is confirmed, the adult purchaser may instruct that edits be made and again reviewed, finally confirming when manufacture may commence, such as by transferring the information to a printer 30 or other device such that the storage container 10 may be completed and shipped to the purchaser. Once manufacture is completed, all data input regarding the container may be removed or retained from the system, depending on the purchaser confidentiality instructions.

Upon receipt by the purchaser P, the medicine and treatment equipment 32 contents listed on the storage container 10 are included by the individual patient P or the individual responsible for the patient within the storage container, and the storage container may then be provided to a care giver for emergency use in connection with the health of the individual patient P, CP.

While the present application for the storage container 10, system and method for providing the storage container, has described in detail, persons skilled in the art will readily understand that it will have applications for a variety of patients have a variety of illnesses. It will of course be understood that the above has been given by way of illustration and that all modifications and variations thereto as would be apparent to persons skilled in the art are deemed to fall within the broad scope and ambit of this invention, as defined in the following claims.

I claim:

1. A system for storage of medical information and medications for an individual patient for use in an emergency health situation, the system comprising a rigid storage container having personalized individual patient medical information mounted for viewing on an external surface of the storage container, including a photograph of the individual patient, and information regarding the contents of the storage container.

2. The system of claim 1, wherein the rigid storage container is semi-transparent enabling the contents of the storage container to be identified when the storage container is closed.

3. The system of claim 1, wherein the external surface of the storage container further includes emergency contact information

4. A method for storing medical information and medications comprising the steps of:
a) using an internet-based computer system to generate a summary of desired individual patient medical information to be mounted for viewing on an external surface of a storage container;
b) supplying the summary of desired individual patient medical information;
c) mounting the summary of desired individual patient medical information for viewing from an external surface of the storage container;
d) providing the storage container with the desired medications listed on the external surface of the storage container;
e) supplying the storage container with the desired individualized patient medical information, treatment materials and medications to a care giver for safe keeping in the event of a health emergency when the storage container and the medical information and medications contained therein may be readily accessed by identification of the summary of desired individual patient medical information viewed on the external surface of the storage container.

5. A computer system for generating medical information for a medical storage container for an individual patient for use during an emergency health situation, comprising:
an electronic database containing information entered by a remote computer system user authorized to provide individual patient medical information;
the electronic database including a medical format for receiving information related to a medical condition associated with the individual patient, identification information associated with the individual patient, emergency contact information and treatment information associated with the individual patient;
the system generating the medical information for application to a semi-transparent, rigid container based upon the information included within the electronic database; and
the system accessible to the authorized user via the internet.
